(19) United States
(12) Patent Application Publication
(10) Pub. No.: US 2008/0148186 A1
(43) Pub. Date: Jun. 19, 2008

(54) SECURE DATA ENTRY DEVICE AND METHOD

(76) Inventor: Sandeep Raman KRISHNAMURTHY, Bangalore (IN)

Correspondence Address: KYOCERA WIRELESS CORP., P.O. BOX 928289, SAN DIEGO, CA, 92192-8289, US

(21) Appl. No.: 11/612,175

(22) Filed: Dec. 18, 2006

(51) Int. Cl. G06F 13/38; G06F 3/048

(52) U.S. Cl. 715/840; 710/67

(57) ABSTRACT

A method for securely entering critical data in a computing device with a keypad, a keypad memory buffer, and a display, the keypad including a layout of keys. The method includes prompting a user to enter critical data into the computing device; generating a virtual keypad having substantially the same layout of keys as the layout on the keypad, with the keys in a random organization; displaying the virtual keypad on the display to the user; prompting the user to enter the critical data per the virtual keypad; receiving inputted data from the keys of the keypad in the keypad memory buffer; mapping the inputted data from the keys of the keypad memory buffer to the keys of the virtual keypad to determine the critical data entered via the virtual keypad, whereby the data read from the keypad memory buffer by any intruding application would not be the critical data; and supplying the critical data for further processing.

### TECHNICAL FIELD

The present invention relates, in general, to devices and methods for securely inputting critical data (e.g., ATM pin), and, in particular, to devices and methods for securely inputting critical data on handheld devices such as mobile phones.

### BACKGROUND

With the advent of mobile commerce (“m-commerce”), one of the potential security threats when entering critical data is that the critical data can be read by reading the contents of the keypad buffer (i.e., with a key press monitor) on the mobile phone. As every key pressed can be located and identified as a particular key, data entered can be simultaneously tracked by software identifying key presses. This kind of tracking could potentially compromise security and privacy.

Thus, a need exists for a simple and effective device and method that allows the user to enter critical data such as ATM pin numbers, credit card numbers, financial account information, and the like in a secure manner.

### SUMMARY

Accordingly, an aspect of the invention involves a device and a method by which critical information is collected from the user and passed on to the necessary application in a secure manner, avoiding potential risks like key-press monitors.

Another aspect of the invention involves a method for securely entering critical data in a computing device, such as a wireless communication device, with a keypad, a keypad memory buffer, and a display, the keypad including a layout of keys. The method includes prompting a user to enter critical data into the computing device; generating a virtual keypad having substantially the same layout of keys as the layout on the keypad, with the keys in a random organization; displaying the virtual keypad on the display to the user; prompting the user to enter the critical data per the virtual keypad; receiving inputted data from the keys of the keypad in the keypad memory buffer; mapping the inputted data from the keys of the keypad memory buffer to the keys of the virtual keypad to determine the critical data entered via the virtual keypad, whereby the data read from the keypad memory buffer by any intruding application would not be the critical data; and supplying the critical data for further processing.

An additional aspect of the invention involves a computing device, such as a wireless communication device, for securely entering critical data for further processing. The computing device includes a keypad including a layout of keys; a keypad memory buffer; a display; a central processing unit configured to execute instructions stored in a data storage area and access data stored in a data storage area; one or more modules executable by the central processing unit, the one or more modules configured to prompt a user to enter critical data into the computing device; generate a virtual keypad having substantially the same layout of keys as the layout on the keypad, with the keys in a random organization; display the virtual keypad on the display to the user; prompt the user to enter the critical data per the virtual keypad; receive inputted data from the keys of the keypad in the keypad memory buffer; map the inputted data from the keys of the keypad memory buffer to the keys of the virtual keypad to determine the critical data entered via the virtual keypad, whereby the data read from the keypad memory buffer by any intruding application would not be the critical data; and supply the critical data for further processing.

Another aspect of the invention involves a method for securely entering critical data in a computing device for secure transfer of the critical data across a network, the computing device including a keypad with a layout of keys, a keypad memory buffer, and a display. The method includes receiving a key map from a server of the network, the key map configured for entering critical data into the computing device; using the key map from the server to generate a virtual keypad having substantially the same layout of keys as the layout on the keypad, with the keys of the virtual keypad in a random organization; displaying the virtual keypad on the display to the user; prompting the user to enter the critical data per the virtual keypad; receiving inputted data from the keys of the keypad in the keypad memory buffer; and sending the inputted data from the keys of the keypad in the keypad memory buffer to the server, where critical data is extracted in accordance with the key map.

An aspect embodiment of the invention involves a computing device for securely entering critical data for secure transfer of the critical data across a network. The computing device includes a keypad including a layout of keys; a keypad memory buffer; a display; a central processing unit configured to execute instructions stored in a data storage area and access data stored in a data storage area; one or more modules executable by the central processing unit, the one or more modules configured to receive a key map from a server of the network, the key map configured for entering critical data into the computing device; use the key map from the server to generate a virtual keypad having substantially the same layout of keys as the layout on the keypad, with the keys of the virtual keypad in a random organization; display the virtual keypad on the display to the user; prompt the user to enter the critical data per the virtual keypad; receive inputted data from the keys of the keypad in the keypad memory buffer; and send the inputted data from the keys of the keypad in the keypad memory buffer to the server, where critical data is extracted in accordance with the key map.

### BRIEF DESCRIPTION OF THE DRAWINGS

The details of the present invention, both as to its structure and operation, may be gleaned in part by study of the accompanying drawings, in which like reference numerals refer to like parts.

FIG. 1 is a block diagram illustrating an example wireless communication device according to an embodiment of the present invention in use with a service device in an exemplary m-commerce transaction.

FIG. 2 is a block diagram illustrating an example wireless communication device according to an embodiment of the present invention.

FIG. 3 is a flow diagram illustrating an exemplary method for securely entering critical data in a wireless communication device in accordance with an embodiment of the invention.

FIG. 4 illustrates a generic display and input device of a wireless communication device of the prior art, and shows a conventional method of input of data that could be potentially insecure.

FIG. 5 illustrates an exemplary display and input device of a wireless communication device according to an embodiment of the present invention, and shows how the exemplary method of the present invention may be used to for secure input of critical information for the m-commerce transaction.

FIG. 6 is a block diagram illustrating an exemplary wireless communication device that may be used in connection with the various embodiments described herein.

FIG. 7 is a block diagram illustrating an exemplary computer system that may be used in connection with the various embodiments described herein.

### DETAILED DESCRIPTION

Certain embodiments as disclosed herein provide for devices and methods for securely entering critical data in a wireless communication device for a mobile commerce (“m-commerce”) transaction in accordance with an embodiment of the invention.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

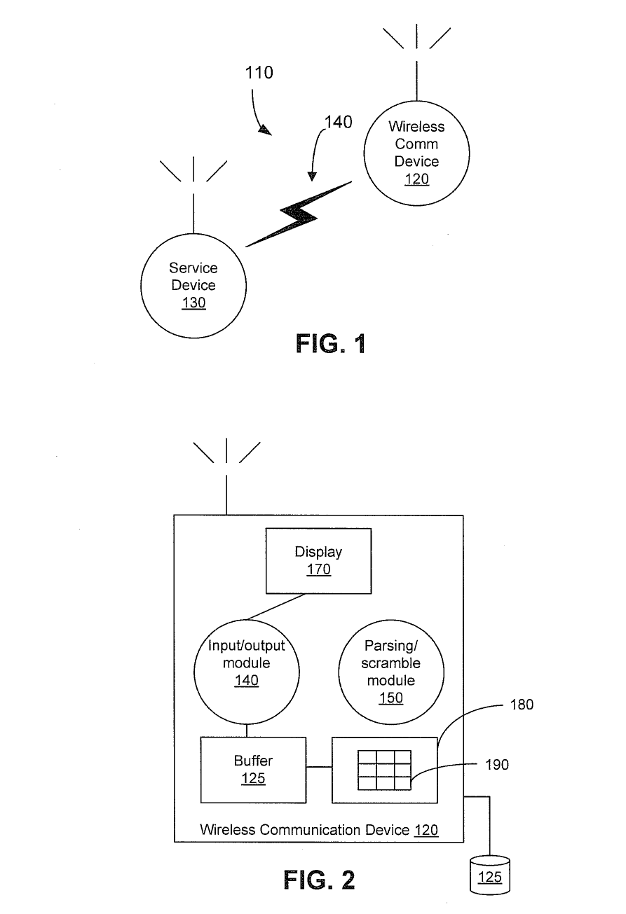

With reference to FIG. 1, a m-commerce system 110 in accordance with an embodiment of the invention is shown. The m-commerce system 110 includes a wireless communication device 120, which is constructed in accordance with an embodiment of the invention, communicatively coupled to a service device 130 through a communication link 140. In the embodiment shown, the communication link 140 is a wireless communication link such as, but not limited to, WIFI, bluetooth, RF, and infrared.

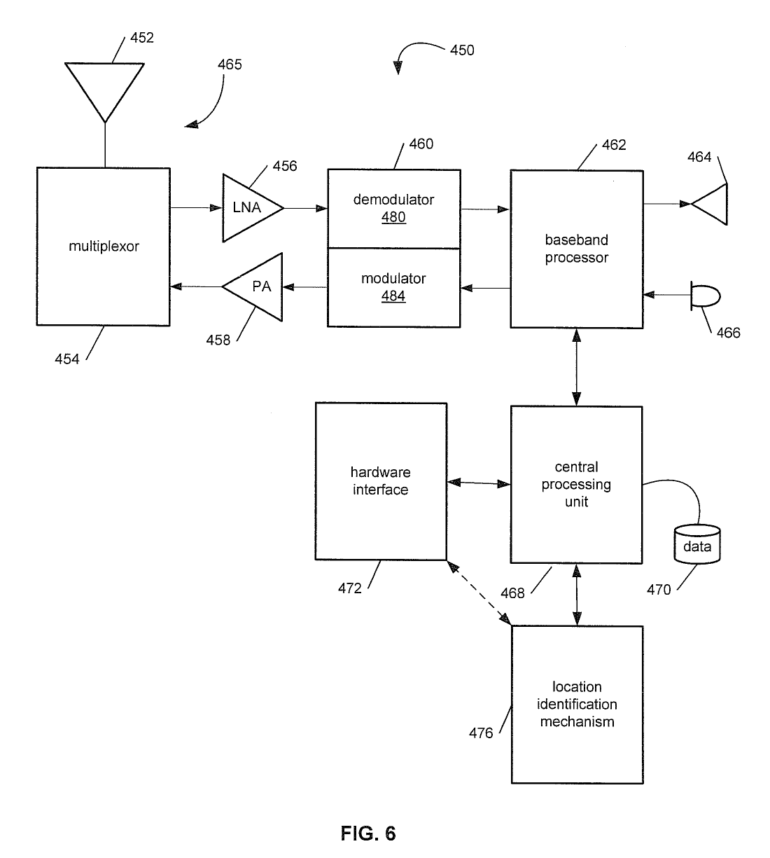

The wireless communication device 120 can be any of a variety of wireless communication devices, including, but not limited to, a cell phone, a personal digital assistant (“PDA”), a personal computer (“PC”), a laptop computer, a PC card, special purpose equipment, or any combination of these and other devices capable of establishing a communication link 140 with the service device 130. An example general purpose wireless communication device is later described with respect to FIG. 6. The wireless communication device 120 may be referred to herein as a handset, wireless device, mobile device, device, wireless unit, or mobile unit.

With reference additionally to FIG. 2, the wireless communication device 120 comprises an input/output module 140 and a parsing/scramble module 150. The input/output module 140 controls the handling of data into and out of the wireless communication device 120. The parsing/scramble module 150 generates and displays a random keypad 160 (FIG. 5) on a display 170 of the wireless communication device 120, and extracts the needed critical payment information (e.g., ATM pin) to complete the m-commerce transaction. The wireless communication device 120 includes a keypad 180 with input keys 190, that, when pressed, cause input data corresponding to the keys 190 to be entered into a keypad buffer 125 of the wireless communication device 120. As used herein, keypad includes a keypad, keyboard, touch screen, or any other input key arrangement for entering data into a computing device.

The service device 130 provides something (e.g., beverage, food, lottery ticket) as part of the m-commerce transaction in exchange for payment. To provide payment information to the service device 130 from the wireless communication device 120 as part of the payment process, payment information such as, but not limited to, credit card information, ATM card information, checking account information, financial account information, and/or pin information is provided. To provide the payment information, critical information (e.g., credit card number, expiration date, pin code) must be input into the wireless communication device 120 using the keys 190 of the keypad 180.

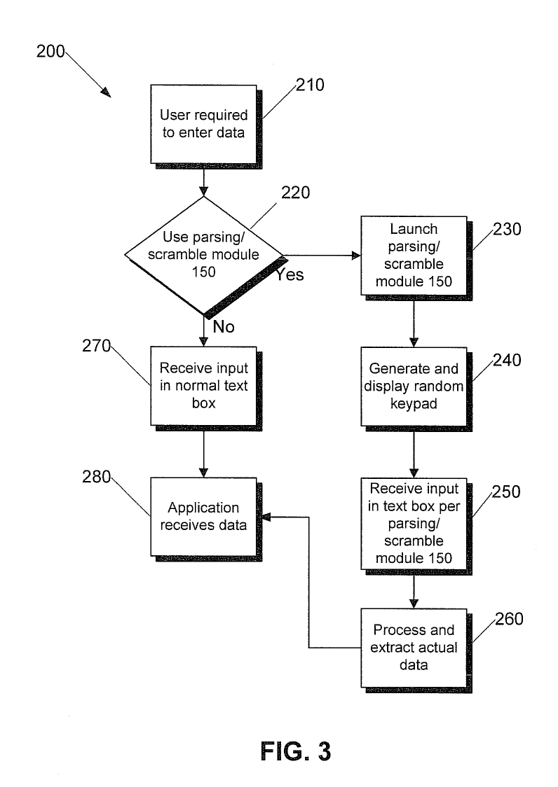

With reference to FIG. 3, an exemplary method 200 for securely entering critical data in the wireless communication device 120 in accordance with an embodiment of the invention will be described.

At step 210, a user us required to enter critical data in the wireless communication device 120.

At step 220, the user is provided the option of actuating an application SP including the parsing/scramble module 150.

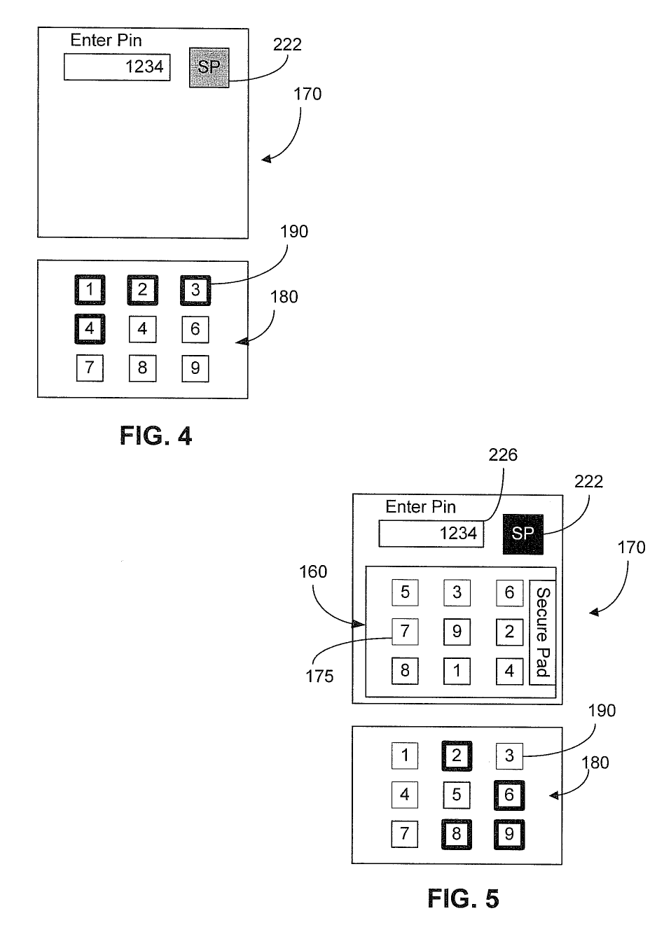

At step 230, the user launches the SP application including the parsing/scramble module 150. With reference to FIG. 4, actuating the SP application including the parsing/scramble module 150 may be performed by highlighting and actuating SP icon 222 on the screen 170. Other methods for activating the SP application may also be or alternatively provided including, invoking a menu selection, invoking a voice command, and invoking a dedicated key, for example. In other embodiments, the SP application may be automatically activated based on a preference setting defined by the user (for example, based on detection of a request for secure or sensitive information, such as passwords within m-commerce applications).

If the module 150 is actuated, at step 240, the parsing/scramble module 150 causes the random, virtual, logical, onscreen keypad 160 (FIG. 5) to be dynamically generated and displayed on the screen 170. The virtual keypad 160 has the same or similar (i.e., substantially similar) layout as the actual keypad 180, but has the keys 175 arranged in a random order. Typically, this virtual keypad 160 generated has keys 175 arranged randomly (or pseudo-randomly) each time to avoid repetition of the key layouts, thereby further enhancing security. The virtual keypad 160 gives the user a visual guide to the keys 190.

The user is prompted to enter the critical data per the onscreen keypad 160. For example, in the embodiment of the random keypad 160 shown in FIG. 5, if the user was to enter an ATM pin code of “1234”, this would be done by first pressing the “8” key 190 (corresponds to “1” on the onscreen keypad 160), then pressing the “6” key 190 (corresponds to “2” on the onscreen keypad 160), then pressing the “2” key 190 (corresponds to “3” on the onscreen keypad 160), and finally pressing the “9” key 190 (corresponds to “4” on the onscreen keypad 160). There is a one-to-one mapping for the keys 190 on the actual keypad 180 and for the virtual onscreen keypad 160.

At step 250, the data (i.e., “1234”) from the random keypad corresponding to the inputted keys 190 is received in text box 226 per the parsing/scramble module 150.

At step 260, the data (i.e., 8629) entered by the user is processed and extracted by the parsing/scramble module 150.

At step 280, the critical data is received by the intended application (e.g., payment processing application).

Thus, to enter a pin code of “1234”, the user enters “8629” on the actual keypad 180, and the actual key press “8629” would be stored in the keypad buffer and hence that would be the value read by any intruding application, which is the incorrect data, preventing the user's critical data from being compromised. The SP application including the parsing/scramble module 150 maps the entered values to the actual values from the onscreen keypad 160, and, hence, the correct value “1234” is sent to the text box 226 as depicted in FIG. 5.

Alternatively, with reference to FIGS. 3 and 4, at step 220, where the user is provided the option of actuating the parsing/scramble module 150, if the user chooses to use the conventional method of input, the user enters data normally. For example, if the user is entering a password of “1234”, the “1” key 190, the “2” key 190, the “3” key 190, and the “4” key are pressed in sequential order in a normal manner for entering input. At step 270, input is received in a normal text box, and at step 280, the data is received by the intended application. In this method of entering data with the keypad 180, an application reading the key strokes can extract the data entered.

Although the system 110 and method 200 are described as applying to a wireless communication device 120 and a service device 130, the system 110 and method 200 also applies to other computing devices and/or for applications other than m-commerce. For example, but not by way of limitation, in alternative embodiments, the system 110 and method 200 includes a personal computer (e.g., desktop, laptop, handheld) where the whole keypad (e.g., QWERTY keypad) is randomized on screen and a virtual keypad is provided to the user in a similar manner to that described above for providing critical data to the personal computer to complete a transaction or in other applications where critical data needs to be provided.

Still further, the system 110 and method 200 is extended to provide an end-to-end or peer-to-peer security mechanism for the user in further embodiments. The system 110 and method 200 is used to safely and securely transfer data across a network (e.g., a wireless network, a voice network, and/or a data network). In this method, the random key map that was generated in the previous implementation would be replaced by a key map, which would be sent by the server to the client. The client utilizes the key map sent by the server to construct the virtual onscreen keypad and collects the data from the user. Thus, encoded data is transferred to the server application where the information is extracted, in accordance with the key map it sent to the client. Thus, the system 110 and method 200 implemented in this end-to-end or peer-to-peer manner, provides a means of encryption.

FIG. 6 is a block diagram illustrating an exemplary wireless communication device 450 that may be used in connection with the various embodiments described herein. For example, the wireless communication device 450 may be used in conjunction with the wireless communication device 120 described above with respect to FIGS. 1-5. However, other wireless communication devices and/or architectures may also be used, as will be clear to those skilled in the art.

In the illustrated embodiment, wireless communication device 450 comprises an antenna system 455, a radio system 460, a baseband system 462, a speaker 464, a microphone 456, a central processing unit (“CPU”) 468, a data storage area 466, a hardware interface 472, and a location identification mechanism 476. In the wireless communication device 450, radio frequency (“RF”) signals are transmitted and received over the air by the antenna system 455 under the management of the radio system 460.

In one embodiment, the antenna system 455 may comprise one or more antennae 452 and one or more multiplexors 454 that perform a switching function to provide the antenna system 455 with transmit and receive signal paths. In the receive path, received RF signals can be coupled from a multiplexor to a low noise amplifier 456 that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator 480 and modulator 484 in one integrated circuit (“IC”). The demodulator and modulator can also be separate components. In the incoming path, the demodulator strips away the RF carrier signal leaving a baseband receive audio signal, which is sent from the radio system 460 to the baseband system 462.

If the received signal contains audio information, then baseband system 462 decodes the signal and converts it to an analog signal. Then the signal is amplified and sent to the speaker 466. The baseband system 462 also receives analog audio signals from the microphone 480. These analog audio signals are converted to digital signals and encoded by the baseband system 462. The baseband system 462 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier 458. The power amplifier 458 amplifies the RF transmit signal and routes it to the antenna system 455 where the signal is switched to the antenna port for transmission.

The baseband system 462 is also communicatively coupled with the central processing unit 468. The central processing unit 468 has access to a data storage area 470. The central processing unit 468 is preferably configured to execute instructions (i.e., computer programs or software) that can be stored in the data storage area 470. Computer programs can also be received from the baseband processor 462 and stored in the data storage area 470 or executed upon receipt. Such computer programs, when executed, enable the wireless communication device 450 to perform the various functions of the present invention as previously described. For example, data storage area 470 may include the modules 210, 220, 230, 240 that were previously described with respect to FIG. 2.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband system 462), antenna system 455 (also via the baseband system 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit 468 is also preferably configured to receive notifications from the hardware interface 472 when new devices are detected by the hardware interface. Hardware interface 472 can be a combination electromechanical detector with controlling software that communicates with the CPU 468 and interacts with new devices. The hardware interface 472 may be a firewire port, a USB port, a Bluetooth or infrared wireless unit, or any of a variety of wired or wireless access mechanisms. Examples of hardware that may be linked with the device 450 include data storage devices, computing devices, headphones, microphones, location identification mechanism 476 and the like.

Location identification mechanism 476 may be any combination of hardware and software for providing/reporting the position of the wireless communication device 120. For example, but not by way of limitation, the location identification mechanism 476 may be a GPS (or A-GPS and AFLT) receiver with appropriate hardware/software. The measurements used to determine position may be done at the wireless communication device 120 and/or by the network.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. In addition, the grouping of functions within a module, block, circuit or step is for ease of description. Specific functions or steps can be moved from one module, block or circuit to another without departing from the invention.

Various embodiments may also be implemented primarily in hardware using, for example, components such as application specific integrated circuits (“ASICs”), or field programmable gate arrays (“FPGAs”). Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. For example, implementation of a hardware state machine capable of performing the functions described herein will also be apparent to those skilled in the relevant art. Various embodiments may also be implemented using a combination of both hardware and software.

Moreover, the various illustrative logical blocks, modules, and methods described in connection with the embodiments disclosed herein can be implemented or performed with a general purpose processor, a digital signal processor, (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

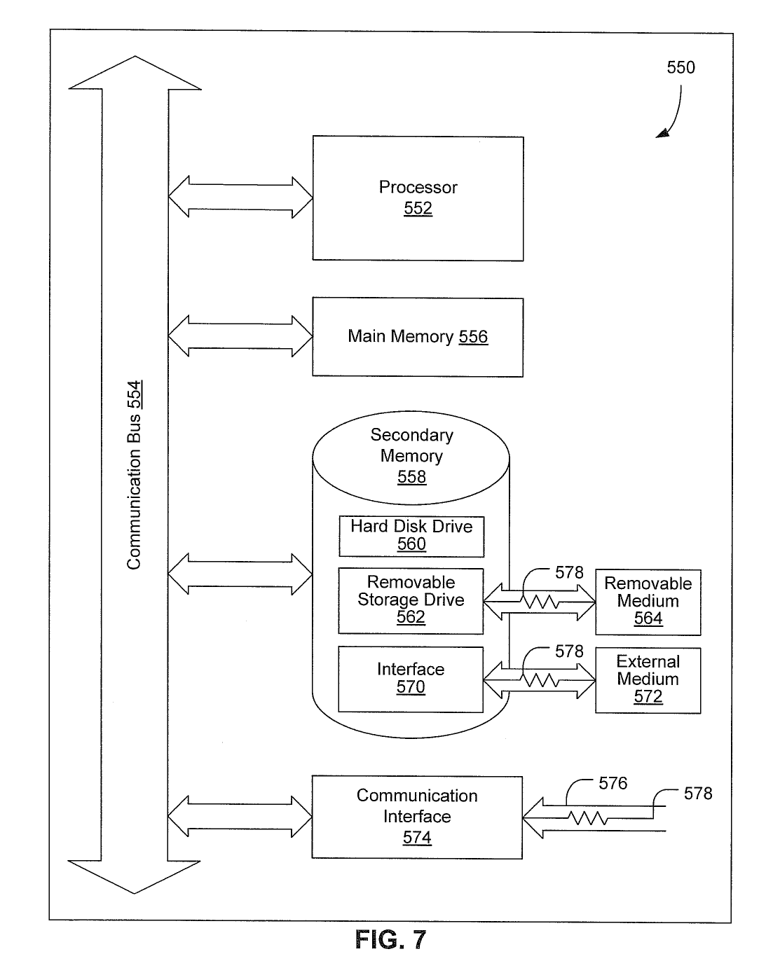

FIG. 7 is a block diagram illustrating an exemplary computer system 550 that may be used in connection with the various embodiments described herein. For example, the computer system 550 (or various components or combinations of components of the computer system 550) may be used in conjunction with the personal computer embodiment of the invention described above and/or for the servers previously described. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, wired phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for securely entering critical data in a computing device with a keypad, a keypad memory buffer, and a display, the keypad including a layout of keys, comprising:
prompting a user to enter critical data into the computing device;
generating a virtual keypad having substantially the same layout of keys as the layout on the keypad, with the keys in a random organization;
displaying the virtual keypad on the display to the user;
prompting the user to enter the critical data per the virtual keypad;
receiving inputted data from the keys of the keypad in the keypad memory buffer;
mapping the inputted data from the keys of the keypad memory buffer to the keys of the virtual keypad to determine the critical data entered via the virtual keypad, whereby the data read from the keypad memory buffer by any intruding application would not be the critical data;
supplying the critical data for further processing.

2. The method of claim 1, wherein supplying the critical data for further processing includes supplying the critical data for processing a mobile commerce transaction.

3. The method of claim 2, wherein the critical data is at least one of a password, and financial account information.

4. The method of claim 3, wherein the computing device is a wireless communication device.

5. A computing device for securely entering critical data for further processing, comprising:
a keypad including a layout of keys;
a keypad memory buffer;
a display;
a central processing unit configured to execute instructions stored in a data storage area and access data stored in a data storage area;
one or more modules executable by the central processing unit, the one or more modules configured to:
prompt a user to enter critical data into the computing device,
generate a virtual keypad having substantially the same layout of keys as the layout on the keypad, with the keys in a random organization,
display the virtual keypad on the display to the user,
prompt the user to enter the critical data per the virtual keypad,
receive inputted data from the keys of the keypad in the keypad memory buffer,
map the inputted data from the keys of the keypad memory buffer to the keys of the virtual keypad to determine the critical data entered via the virtual keypad, whereby the data read from the keypad memory buffer by any intruding application would not be the critical data,
supply the critical data for further processing.

6. The computing device of claim 5, wherein the one or more modules are configured to supply the critical data for processing a mobile commerce transaction.

7. The computing device of claim 6, wherein the critical data is at least one of a password, and financial account information.

8. The computing device of claim 7, wherein the computing device is a wireless communication device.

9. A method for securely entering critical data in a computing device for secure transfer of the critical data across a network, the computing device including a keypad with a layout of keys, a keypad memory buffer, and a display, comprising:
receiving a key map from a server of the network, the key map configured for entering critical data into the computing device;
using the key map from the server to generate a virtual keypad having substantially the same layout of keys as the layout on the keypad, with the keys of the virtual keypad in a random organization;
displaying the virtual keypad on the display to the user;
prompting the user to enter the critical data per the virtual keypad;
receiving inputted data from the keys of the keypad in the keypad memory buffer;
sending the inputted data from the keys of the keypad in the keypad memory buffer to the server, where critical data is extracted in accordance with the key map.

10. The method of claim 9, wherein the network is at least one of a wireless network, a voice network, and a data network.

11. The method of claim 9, wherein the critical data is at least one of a password, and financial account information.

12. The method of claim 9, wherein the computing device is a wireless communication device.

13. A computing device for securely entering critical data for secure transfer of the critical data across a network, comprising:
a keypad including a layout of keys;
a keypad memory buffer;
a display;
a central processing unit configured to execute instructions stored in a data storage area and access data stored in a data storage area;
one or more modules executable by the central processing unit, the one or more modules configured to:
receive a key map from a server of the network, the key map configured for entering critical data into the computing device;
use the key map from the server to generate a virtual keypad having substantially the same layout of keys as the layout on the keypad, with the keys of the virtual keypad in a random organization;
display the virtual keypad on the display to the user;
prompt the user to enter the critical data per the virtual keypad;
receive inputted data from the keys of the keypad in the keypad memory buffer;
send the inputted data from the keys of the keypad in the keypad memory buffer to the server, where critical data is extracted in accordance with the key map.

14. The computing device of claim 13, wherein the network is at least one of a wireless network, a voice network, and a data network.

15. The computing device of claim 13, wherein the critical data is at least one of a password, and financial account information.

16. The computing device of claim 13, wherein the computing device is a wireless communication device.
